(19) United States
(12) Patent Application Publication
(10) Pub. No.: US 2013/0136803 A1
(43) Pub. Date: May 30, 2013

(54) COMPOSITIONS FOR ALGAE TREATMENT IN RECIRCULATING AND STAGNANT WATER SYSTEMS

(71) Applicant: ARCH CHEMICALS, INC., Atlanta, GA (US)

(72) Inventors: Michael J. UNHOCH, Tyrone, GA (US); Mirtha-Sofia URIBE, Doraville, GA (US)

(73) Assignee: ARCH CHEMICALS, INC., Atlanta, GA (US)

(21) Appl. No.: 13/689,099

(22) Filed: Nov. 29, 2012

Related U.S. Application Data
(60) Provisional application No. 61/564,928, filed on Nov. 30, 2011.

(51) Int. Cl. A01N 59/16

(52) U.S. Cl. CPC A01N 59/16
USPC 424/641

(57) ABSTRACT

The present invention provides a composition for treating recirculating or stagnant water. The composition contains a phosphorus-containing compound, which is metaphosphate compound, a polyphosphoric acid or a polyphosphate, and one or more zinc compounds. The phosphorus-containing compound is a compound which is not readily hydrolyzable to an orthophosphate.

In another aspect of the present invention, provided is a method of controlling algae in a body of recirculating or stagnant water using the composition.

### CROSS-REFERENCE TO RELATED APPLICATION

This application claims priority under 35 U.S.C. §119(e) from U.S. Ser. No. 61/564,928 filed Nov. 30, 2012. The disclosure of U.S. Ser. No. 61/564,928 is incorporated herein by reference in its entirety.

### FIELD OF THE INVENTION

The present invention relates to a water treatment composition which is useful for treating recirculating and stagnant water systems. The water treatment composition contains a phosphorus-containing compound, which is not readily hydrolyzed to an orthophosphate; and a zinc compound. Also the present invention relates to the treatment and prevention of algae in recirculating and stagnant water systems.

### BACKGROUND OF THE INVENTION

Algae contamination in water systems such as swimming pools is the result of a combination of nutrients and sunlight. Nitrogen, phosphorus, and potassium are all found in pool water, while sunlight provides a source of energy for photosynthesis. Algae have always been a nuisance organism in swimming pools and spas that is difficult to prevent and remediate. Algae cause the pool to become cloudy and green colored, pool surfaces to become discolored and slippery and not visually appealing to potential users or observers. While many treatments have been proposed to address algal contamination, the challenge has always been to find a stable and effective treatment to prevent algae from appearing.

There are many different algaecides for treatment of water. Zinc compounds and zinc salts may be used as an effective preventative treatment for algae contamination, but should be used sparingly. This is because at higher concentrations, generally above about 5 ppm, zinc salts will impart an unpleasant metallic taste to the water. Commonly used organic algaecides are not as persistent as zinc and can consume the sanitizer in the water. Also organic algaecides are not compatible with oxidizing biocides. In addition, organic algaecides are often added apart from a sanitizer, generally as a separate either of a system combined with sanitizer and/or oxidizer to prevent algal contamination in swimming pools.

Many different chelating agents are commonly used in swimming pools to control staining and scale formation without regard to the algae preventative treatments being employed. However, the chelating agent may also adversely affect the zinc compound or zinc salts used as the algaecide. That is, the chelating agent may serve to bind the active zinc. Therefore, it is important to use the right chelating agent to control staining and scale formation without affecting the algae treatment.

Separately, sodium hexametaphosphate (SHMP) has many uses in swimming pools and recreational water systems. SHMP is used as a water softener and a pH modifier, and is compatible with many sanitizers (e.g., chlorine or chlorine sources) commonly used to clarify and disinfect or sanitize pool water. However, many phosphate chelating agents can hydrolyze to orthophosphate which is a potential nutrient source for algae.

A variety of methods and compositions for controlling microorganism growth, as well as algae growth, in swimming pools have been disclosed.

U.S. Patent Application Publication 2011/0045977 to Unhoch et al. discloses water treatment compositions using a stable formulation of polyhexamethylene biguanide (PHMB) and a liquid or solid zinc salts for the application and prevention algae in recirculated and stagnant water systems.

U.S. Patent Application Publication 2008/0274208 discloses a composition for reducing the levels of microorganisms in recreational water systems, comprising: (1) a biocidal effective amount of dibromonitrilopropionamide (DBNPA); (2) optionally, a biocidal effective amount of an algaecide selected from the group consisting of didecyldimethylammonium chloride (DDAC), zinc, and copper; and (3) optionally, a compound capable of in situ activation to form an oxidizing agent.

U.S. Patent Application Publication 2008/0142453 discloses a composition for treating recirculating water systems, comprising: (1) a biocidal effective amount of a first nonoxidizing biocide comprising biguanide; and (2) a biocidal effective amount of a second nonoxidizing biocide comprising dibromonitrilopropionamide (DBNPA); wherein the composition is substantially free from oxidants.

U.S. Pat. No. 7,122,505 discloses a stable aqueous concentrate comprising a polymeric biguanide, a chelating agent and a water-miscible organic solvent for controlling the growth of algae, fungi and pathogenic organisms in water.

U.S. Pat. No. 6,710,017 discloses compositions for controlling the growth of nuisance algae in a recirculating water system which comprises any of a herbicide having anti-algal activity in said water system, an agricultural fungicide having anti-algal activity in said water system or a combination thereof, and a sanitizing agent.

U.S. Pat. No. 5,449,658 discloses a method for controlling the growth of algae, fungi and pathogenic organisms in commercial and recreational water, comprising adding to the water a composition comprising poly(hexamethylene biguanide) hydrochloride (PHMB) as a primary sanitizing agent and a potentiating adjuvant comprising ethylenediamine-tetraacetic acid or a salt thereof (EDTA) as a calcium ion-chelating agent, in amounts such that the PHMB concentration in the water is about 3 to 14 ppm and the EDTA concentration in the water is about 1.5 to 36 ppm and the adjuvant renders the composition algaecide and fungicidal in the water.

Accordingly, there is a need in the art for a water treatment composition that will be effective in controlling algae, but also has the advantages of a chelating agent. The present invention provides an answer to that need.

### SUMMARY OF THE INVENTION

In one aspect, the present invention provides a composition for treating recirculating or stagnant water. The composition contains a phosphorus-containing compound, which is metaphosphate compound, a polyphosphoric acid or a polyphosphate; and one or more zinc compounds. The phosphorus-containing compound is a compound which is not readily hydrolyzable to an orthophosphate.

In another aspect of the present invention, provided is a method of controlling algae in a body of recirculating or stagnant water. The method contains the steps of: a) providing a body of recirculating or stagnant water containing algae, and b) adding to said body of recirculating or stagnant water a composition containing a phosphorus-containing compound, which is a metaphosphate compound, a polyphosphoric acid and a polyphosphate, and one or more zinc compounds. The phosphorus-containing compound is a compound which is not readily hydrolyzable to an orthophosphate.

These and other aspects will become apparent when reading the detailed description of the invention.

### BRIEF DESCRIPTION OF THE DRAWINGS

The invention will be better understood from the following detailed description and accompanying drawings, in which:

FIG. 1 is a graph showing the effect of 2 ppm zinc ions and 2 ppm selected chelators on an algae biomass over time;

FIG. 2 is a graph showing the effect of 2 ppm zinc ions and 10 ppm selected chelators on an algae biomass over time;

FIG. 3 is a graph showing the effect of 4 ppm zinc ions and 2 ppm selected chelators on an algae biomass over time; and

FIG. 4 is a graph showing the effect of 4 ppm zinc ions and 10 ppm selected chelators on an algae biomass over time.

### DETAILED DESCRIPTION OF THE INVENTION

It has now been surprisingly found that both zinc compounds salts and phosphorus-containing compounds are compatible with many sanitizers used in swimming pools, spas, and others bodies of water, and are quite persistent in application. By incorporating phosphorus-containing compounds and zinc compounds with the swimming pool and/or spa sanitizers, shocks and other pool and spa maintenance products, the pool owner can be provide with an easier system to keep their pool free from algae even during short periods of time when there is no sanitizer residual present.

As indicated above, the present invention is directed to a composition for treating recirculating or stagnant water, containing a phosphorus-containing compound and one or more zinc compounds. Each of these components is described in more detail below.

The phosphorus containing compound is a compound which is a metaphosphate compound, a polyphosphoric acid or a polyphosphate. Exemplary metaphospates include, but are not limited to, sodium trimetaphosphate, sodium metaphosphoric acid, sodium polymetaphosphate, sodium hexametaphosphate (SHMP), potassium trimetaphosphate, potassium metaphosphoric acid, potassium polymetaphosphate, potassium hexametaphosphate, calcium trimetaphosphate, calcium metaphosphoric acid, calcium polymetaphosphate, calcium hexametaphosphate, aluminum trimetaphosphate, aluminum metaphosphoric acid, aluminum polymetaphosphate, aluminum hexametaphosphate and other similar salts, polyphosphoric acid and polyphosphates or salts thereof. The only limitation on the phosphorus-containing compounds must be a compound which does not readily hydrolyze into an orthophosphate. By “does not readily hydrolyze into an orthophosphate” it is intended that the phosphorus-containing compound does not convert to the orthophosphate when introduced into water or through reaction or interaction with other chemicals used to treat water. Of these phosphorus-containing compounds, the metaphosphates are of particular interest and the alkali metal metaphosphates are of more particular interest. Of the alkali metal metaphosphates, sodium hexametaphosphate (SHMP) is particularly stable and effective as the phosphorus containing compound.

The phosphorus-containing compound is present in the composition in a solid, liquid, or solution form. Generally, the amount of solid phosphorus containing compounds in the composition ranges from 0.1 to 99.9 wt %, typically from 5 to 98 wt %, and more typically from 10 to 90 wt %, all weight percents being based on the total weight of the composition. When formulated as a liquid or solution, the amount of phosphorus-containing compound ranges from 0.1 to about 40% by weight of the composition.

One or more water soluble zinc compounds are also included in the composition to provide a source of zinc ions (Zn²⁺). Suitable water soluble zinc compounds include, but are not limited to, zinc oxide, zinc hydroxide and zinc salts, including, but not limited to, zinc chloride, anhydrous zinc sulfate, zinc sulfate monohydrate (ZnSO₄.H₂O), zinc sulfate heptahydrate (ZnSO₄.7H₂O), zinc carbonate (ZnCO₃), zinc nitrate (Zn(NO₃)₂), zinc borate, zinc phosphate, and combinations thereof. One particular zinc compound is the zinc salt, zinc sulfate monohydrate. The amount of zinc compounds in the composition are generally in the range from 0.1 to 95 wt % in solid form, typically from 1 to 30 wt %, and more particularly from 2 wt % to 25 wt %, with all weight percents being based on the total weight of the composition. When formulated as a liquid or solution, the amount of zinc compound will generally range from 0.1 to 10% by weight of the composition.

Given the foregoing weight percentage of the zinc compound and the phosphorus-containing compound, the actual amounts may vary greatly depending on the composition. More important than the actual weight amounts of each component in the composition is the weight ratio of the zinc compound to the phosphorus-containing compound. Generally, the composition will have a weight ratio of the zinc to phosphorus-containing compound that is in the range of about 10:1 to about 1:100. That is, the zinc compound is present in a range of about 10 parts (weight) zinc compound per 1 part (weight) phosphorus-containing-compound to about 1 part zinc compound per 100 parts of the phosphorus containing compound. Typically, the weight ratio zinc compound to phosphorus containing compound will be in the range of about 4:1 to about 1:50; more typically about 2:1 to about 1:20. Particularly, the ratio of zinc compound to phosphorus-containing compound will be in the range of about 1:1 to 1:10; and more particularly in the range of about 1:1 to 1:7. If additional ingredients (discussed below) are present, the weight ratio to the zinc compound to the phosphorus-containing compound should remain in the above described weight ratios.

The components of the composition of the invention are combined using conventional techniques and may be formed into powders, granules, liquids, emulsions, suspensions, tablets, or briquettes. In use, 500 grams (made from, for example, 400 g phosphorus-containing compound and 100 g zinc compound) of the composition may be initially added to 10,000 gallons (37.85 m³) of pool water followed by weekly additions of 100 g per 10,000 (37.85 m³) gallons of pool water to maintain phosphorus-containing compound and zinc levels needed to achieve the desired result. The desired result can also be obtained by adding 100 g weekly additions of the solid or initial dose followed by weekly additions per 10,000 gallons (37.85 m³). In one embodiment, the composition of the invention delivers 0.5 to 10 ppm final concentration of zinc ions, more preferably from 1 to 5 ppm final concentration of zinc ions, and most preferably from 2 to 4 ppm final concentration of zinc ions. The composition of the invention also delivers from 1 to 50 ppm final concentration of phosphorus containing compound, more preferably from 2 to 25 ppm final concentration of phosphorus-containing compound, and most preferably from 5 to 10 ppm final concentration of phosphorus-containing compound.

Additionally, phosphorus-containing compound and zinc compound may be applied as an “initial dose” to establish initial phosphorus-containing compound and zinc ion residuals in the body of water. Following the initial dose, daily or weekly doses of the composition may be added to act as a maintenance/preventative step to prevent further growth of algae. In one embodiment, a sufficient amount of the “initial dose” composition is added to water to achieve a phosphorus-containing compound concentration of about 2-10 ppm, and a zinc ion concentration of between 2 and 4 ppm.

In the method of the present invention, first a body of water containing recirculating water or stagnant water containing algae is provided. By “provided” it is intended to include all aspect of providing a suitable body of water, including locating, finding, being directed to the water, owning the body of water, serving the body of water and the like. Once provided, it may be determined if algae is present in the body of water. If present, the composition of the present invention is added to the water. Alternatively, the composition of the present invention may be added to a body of water not containing algae, to prevent the growth of algae with the body of water.

The compositions according to the present invention may also contain additives known in the water treatment art. These additives include but are not limited to pigments, dissolution rate modifiers, binders, water softeners, phosphate removers, corrosion inhibitors, dissolution rate modifiers, oxidizers (peroxysalts, percarbonates, persulfates, perborates, and peroxides), lubricants, color-containing salts, biocides, buffers, chelating agents, other algaecides, fungicides, sequestering agents, clarifiers, enzymes, dyes, thickeners, fragrances, surfactants, co-solvents, biodisperants, biopenetrants, sorbitan monostearate, sulfamic acid, N-tallow-1,3-propylene diamine, N-coco-1,3-propylene diamine, N-oleyl-1,3-propylene diamine, stearyldimethylbenzylammonium chloride, fluorinated polymers, and combinations thereof. The composition of the invention may also include other additional ingredients such as clarifiers (organic and inorganic), enzymes, stabilizers (cyanuric acid), borates, water softeners, dyes or pigments, organic or inorganic algaecides, water balance components, scale inhibitors, corrosion inhibitors, oxidizers, or any other commonly used pool and spa products, as well as combinations of these. Particularly useful additional ingredients include chlorite salts, hypochlorite salts (e.g., calcium hypochlorite, lithium hypochlorite), chlorinated isocyanurates such as dichloroisocyanurate salts (e.g., sodium or potassium dichloroisocyanurate), and trichloroisocyanurates salts (e.g., sodium or potassium trichloroisocyanurate), halogenated hydantoins, polyhexamethylbiguanide (PHMB), persulfates (e.g., potassium monopersulfate), persalts, halide salts, and combinations thereof.

These additives may be pre-blended with any of the components of the composition, and are generally present in the composition of the invention in amounts ranging from 0.2 to 90 weight percent of the composition. The actual amount of these additives is generally not critical so long as the weight ratio of the zinc compound to the phosphorus-containing compound is within the ranges described herein.

The composition and method of the present invention may be used in any recirculating water system where algae infestation could occur, for example swimming pools, spas, hot tubs, and decorative ponds. In use as a treatment for swimming pools, the composition of the invention is added to a swimming pool recirculating water system to achieve desired concentration ranges and demonstrates a synergistic effect between the ingredients. In addition, the composition of the present invention may also be used to treat stagnant water, such as ponds, lakes, canals and the like.

The following examples are meant to illustrate, but in no way limit the present invention.

### EXAMPLE

### Example 1

### Efficacy of Zinc and SHMP Against Mustard Algae

A. Algae Culture

A wild mustard algae strain isolated from a residential swimming pool was used in this study. This strain was re-suspended into sterile capped flasks of 250 ml capacity, containing 100 ml sterile Kratz/Meyers (KM) algae medium. Algae stock cultures were incubated at room temperature with a 16/8 hours on/off cycle white fluorescent lighting for approximately 2 weeks to obtain actively growing liquid cultures at the time of experiment.

B. Testing

Sterile KM medium was dispensed in 50 ml aliquots into sterile 125 ml capped Erlenmeyer flasks containing 40 glass beads of 6 mm diameter. Beads provided an increased surface area for algae to attach, since this alga develops as a loosely attached yellow growth on pool surfaces. Simultaneously, beads helped to homogenize samples by grinding at the time of sampling. An initial mustard algae culture of approximately 2×104 was set into each flask. Cultures were incubated under fluorescent lighting with a 16/8 hour on/off hour cycle for 3 weeks without agitation or additional aeration. Temperature was maintained at 24° C.±2° C. All experiments were conducted in triplicates.

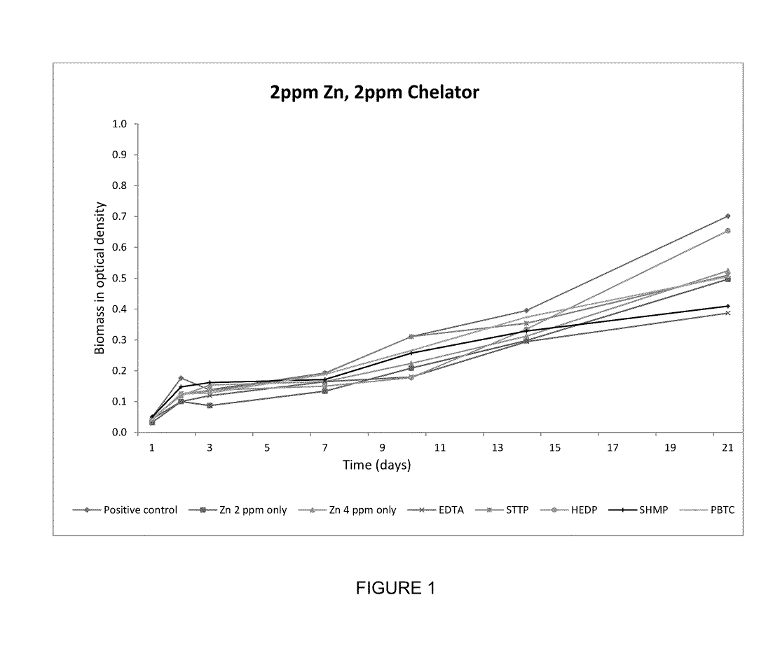

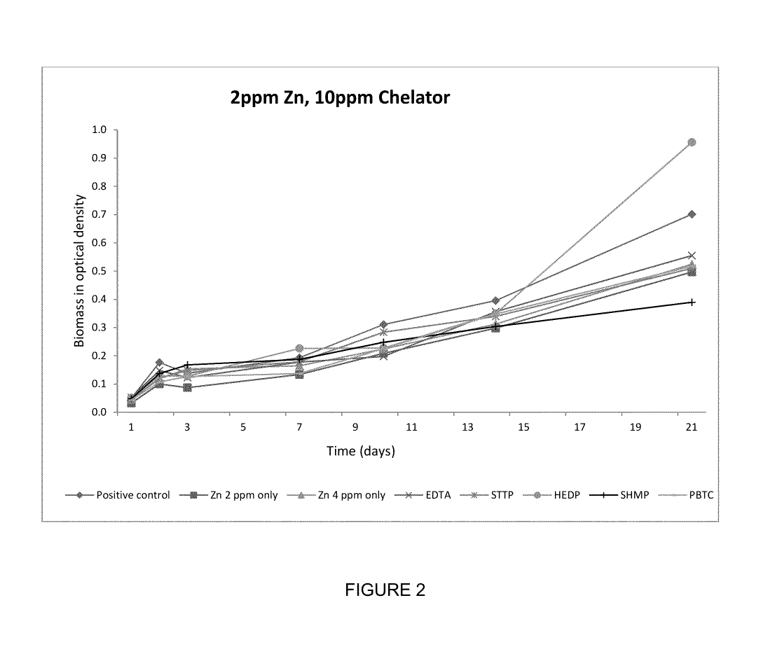

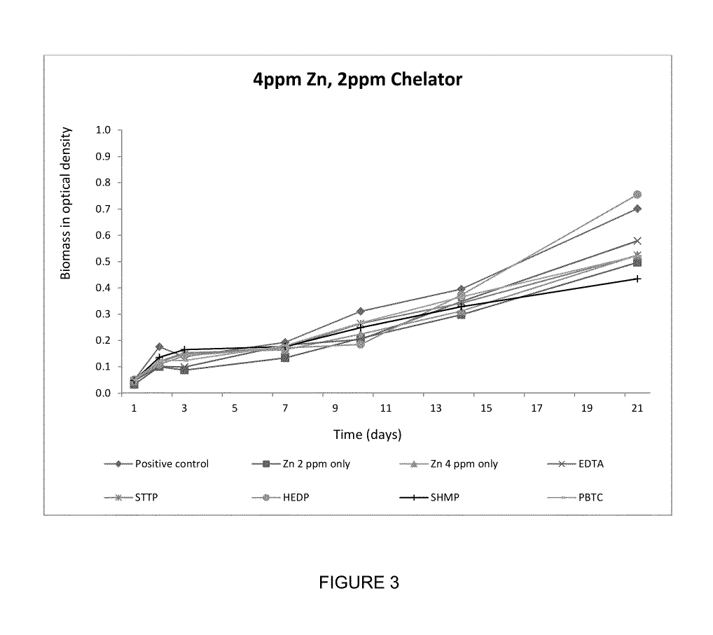

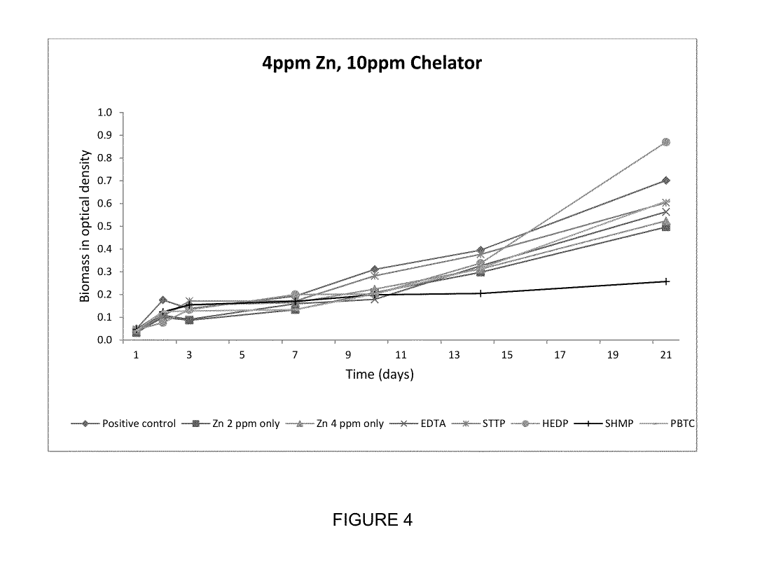

Algal cultures were challenged with 2 or 4 ppm zinc from zinc sulfate monohydrate combined with 2 or 10 ppm chelator. Both zinc concentrations were expected to occur in typical pool water, whereas chelating agents were considered a habitual level (2 ppm), and an excess (10 ppm). Biomass was measured over time by surrogate parameters: absorbance and visual assessment. Absorbance was measured at 450 nm using 1 inch cell in a spectrophotometer; visual assessment range was 0-3, where “0” equal to no growth and “3” equal to very heavy growth. The results of the optical readings were arithmetically averaged. In addition, a direct measurement by microscopic counting at the end of the study was performed for each flask to determine yield. The results and effects of chelating agents on zinc as an algaestat are shown in FIGS. 1-4. In FIGS. 1-4, a positive control is shown that consisted of a sample containing no zinc ions or chelating agent. Zinc controls (e.g., algae and 2 or 4 ppm zinc in the absence of chelating agent) are also shown. The remaining curves are combinations of zinc ions and chelating agents at the described concentrations (ethylenediaminetetraacetic acid, EDTA; sodium tripolyphosphate, STTP; 1-hydroxy ethylidene-1,1-diphosphonic acid, HEDP; sodium hexametaphosphate, SHMP; 2-phosphonobutane-1,2,4-tricarboxylic acid, PBTC).

As shown in FIGS. 1-4, sodium hexametaphosphate (SHMP) was the only chelating agent that enhanced the performance of the algaestatic activity of zinc ions at all concentrations. This effect was observed as low as a 2:1 ratio of zinc to SHMP and the effect became greater with increasing amount of SHMP to a ratio of 1:5. The other chelating agents when combined with the zinc exhibited similar or worse activity to the zinc alone.

While the invention has been described above with references to specific embodiments thereof, it is apparent that many changes, modifications and variations can be made without departing from the invention concept disclosed herein. Accordingly, it is intended to embrace all such changes, modifications, and variations that fall within the spirit and broad scope of the appended claims. All patent applications, patents, and other publications cited herein are incorporated by reference in their entireties.

What is claimed is:

1. A composition for treating recirculating or stagnant water, said composition comprising
a phosphorus-containing compound selected from the group consisting of metaphosphate compound, a polyphosphoric acid and a polyphosphate; and
one or more water soluble zinc compounds,
wherein the phosphorus-containing compound is a compound which is not readily hydrolyzable to an orthophosphate.

2. The composition according to claim 1, wherein the zinc compound and the phosphorus-containing compound are present in a weight ratio of zinc compound to phosphorus-containing compound in the range of 10:1 to 1:100.

3. The composition of according to claim 2, wherein zinc compound and the phosphorus-containing compound are present in a weight ratio of zinc compound to phosphorus-containing compound in the range of 2:1 to 1:20.

4. The composition according to claim 3, wherein the zinc compound and the phosphorus-containing compound are present in a weight ratio of zinc compound to phosphorus-containing compound in the range of 1:1 to 1:7.

5. The composition according to claim 1, wherein the phosphorous-containing compound is a metaphosphate compound.

6. The composition according to claim 5, wherein the metaphosphate compound is selected from the group consisting of a sodium, potassium, calcium or aluminum salts of trimetaphosphate, a hexametaphosphate, and a polyphosphate.

7. The composition according to claim 1, wherein the phosphorous-containing compound comprises sodium hexametaphosphate.

8. The composition of claim 1, wherein said zinc compound comprises zinc oxide, zinc hydroxide or a zinc salt selected from the group consisting of anhydrous zinc sulfate, zinc chloride, zinc sulfate monohydrate (ZnSO₄.H₂O), zinc sulfate heptahydrate (ZnSO₄.7H₂O), zinc carbonate (ZnCO₃), zinc nitrate (Zn(NO₃)₂), zinc borate, zinc phosphate, and combinations thereof.

9. The composition according to claim 8, wherein the phosphorus-containing compound comprises sodium hexametaphosphate.

10. The composition according to claim 9, wherein the zinc compound and sodium hexametaphosphate are present in a weight ratio of zinc compound to sodium hexametaphosphate compound is in the range of 1:1 to 1:7.

11. The composition according to claim 10, wherein the zinc compound comprises zinc sulfate monohydrate.

12. The composition according claim 1, wherein said zinc compound is in liquid or solution form and comprises from 0.1 up to 10 percent by weight, based on the total weight of said composition and the phosphorus-containing compound is in liquid or solution form and comprises from 0.1 up to 40 percent by weight, based on the total weight of the composition.

13. The composition according claim 1, further comprising one or more additional ingredients selected from the group consisting of chlorite and hypochlorite salts, chlorinated isocyanurates, chloroisocyanuric acid, polybiguanides, persalts, halide salts, halogenated hydantoins and combinations thereof.

14. The composition according claim 1, further comprising one or more additional ingredients selected from the group consisting of clarifiers organic and inorganic, enzymes, stabilizers cyanuric acid, borates, water softeners, dyes, pigments, organic or inorganic algaecides, water balance components, scale inhibitors, corrosion inhibitors, oxidizers, and combinations thereof.

15. A method of controlling algae in a body of recirculating or stagnant water, comprising the steps of:
a) providing a body of recirculating or stagnant water containing algae; and
b) adding to said body of recirculating or stagnant water an effective amount of a composition comprising a phosphorus-containing compound selected from the group consisting of metaphosphate compound, a polyphosphoric acid and a polyphosphate, and one or more water soluble zinc compounds,
wherein the phosphorus-containing compound is a compound which is not readily hydrolyzable to an orthophosphate.

16. The method according to claim 15, wherein said zinc compound is selected from the group consisting zinc oxide, zinc hydroxide or a zinc salt selected from the group consisting of anhydrous zinc sulfate, zinc chloride, zinc sulfate monohydrate (ZnSO₄.H₂O), zinc sulfate heptahydrate (ZnSO₄.7H₂O), zinc carbonate (ZnCO₃), zinc nitrate (Zn(NO₃)₂), zinc borate, zinc phosphate, and combinations thereof.

17. The method according claim 16, wherein said adding said composition comprises adding the composition in an amount to the water that results in a final concentration of zinc ion in said water of between 0.5 and 10 ppm, and a final concentration of phosphorus-containing compound in said water of between 1 and 50 ppm.

18. The method according to claim 17, wherein the composition in an amount to the water that results in a final concentration of zinc ion in said water of between 1.0 and 5 ppm, and a final concentration of phosphorus-containing compound in said water of between 2 and 25 ppm.

19. The method according to claim 18, wherein the composition in an amount to the water that results in a final concentration of zinc ion in said water of between 2.0 and 4.0 ppm, and a final concentration of phosphorus-containing compound in said water of between 5 and 10 ppm.

20. The method according to claim 19, wherein the phosphorus-containing compound comprises sodium hexametaphosphate and the zinc compound comprises zinc sulfate monohydrate.
